(19) United States
(12) Patent Application Publication
(10) Pub. No.: US 2026/0209039 A1
(43) Pub. Date: Jul. 23, 2026

(54) METHOD FOR PRODUCTION OF SYNGAS BY PLASMA-ENABLED CONVERSION

(71) Applicant: Redshift Energy, Inc., Corpus Christi, TX (US)

(72) Inventors: Alexander Gutsol, Flourtown, PA (US); Yuriy Mirochnik, Philadelphia, PA (US)

(21) Appl. No.: 19/283,697

(22) Filed: Jul. 29, 2025

Related U.S. Application Data
(60) Provisional application No. 63/677,020, filed on Jul. 30, 2024.

(51) Int. Cl. C01B 3/34; B01J 19/08

(52) U.S. Cl. CPC C01B 3/342; B01J 19/088; B01J 2219/00103; B01J 2219/0845; B01J 2219/0869; B01J 2219/0883; B01J 2219/0898; C01B 2203/0216; C01B 2203/0222; C01B 2203/0861; C01B 2203/1241

(57) ABSTRACT

A method to produce syngas is disclosed herein which includes continuously flowing a mixture comprising a hydrocarbon, and a gaseous converting agent comprising one or more of carbon dioxide (CO₂) and water vapor (H₂O), at an inlet temperature through a reactor inlet into a plasma-chemical reactor while inputting an amount of electrical energy into the mixture thereby forming a plasma from the mixture within the reactor thereby increasing an enthalpy of the mixture sufficiently to form a product syngas from the mixture comprising hydrogen, carbon monoxide, and less than or equal to about 0.1 mol % solid carbonaceous compounds, based on a total amount of carbon initially present in the mixture; and flowing the product syngas through a reactor outlet of the plasma-chemical reactor and cooling the product syngas to a temperature of less than or equal to about 700 K, wherein a conversion of the hydrocarbons is greater than or equal to about 90 mol %, based on an initial amount of hydrocarbon present in the mixture.

### CROSS REFERENCE TO RELATED APPLICATIONS

This application claims benefit to U.S. Provisional patent application 63/677,020 filed Jul. 30, 2024, the entire disclosure of which is incorporated by reference herein.

### GOVERNMENT LICENSE RIGHTS

This invention was made with government support under Grant #DE-SC0024005 awarded by the US Department of Energy. The US government has certain rights in the invention.

### FIELD OF THE DISCLOSURE

The instant disclosure is generally directed to methods and apparatus for formation of syngas. More particularly, to plasma-enabled formation of syngas.

### BACKGROUND

The present disclosure is directed towards dry, steam, and combined steam-dry reforming (CSDR) of methane, typically supplied as a natural or associated gas, to synthesis gas (“syngas”). CSDR is also referred to in the art as “SDR” and the acronym may be used interchangeably herein. The term syngas is used herein consistent with a common understanding in the art to refer to a mixture primarily comprising hydrogen (H₂) and carbon monoxide (CO) as well as other minor components such as carbon dioxide (CO₂) and methane (CH₄), and the like. Syngas is used in numerous commercial processes, including the production of ammonia, methanol, synthetic fuels, and the like.

The production of syngas from natural gas via methods currently known in the art has been found to be uneconomical, or ecologically unattractive, since methods known in the art utilize natural gas to produce the thermal energy necessary for syngas production from the same natural gas, or associated gas streams. Replacement of the heating energy now obtained from natural gas chemical energy by electric energy to support the various endothermic processes of syngas generation results in avoidance or reduction of carbon dioxide (CO₂) emission and further allows for the potential increase in syngas production by 50% from the same quantity of natural gas currently used.

Syngas is produced via methane reforming, which involves heating methane with a gaseous converting agent (steam and/or CO₂) to high temperature (above 1000 K) in the presence of a catalyst. Two major types of syngas production include steam methane reforming (SMR) according to formula (I):

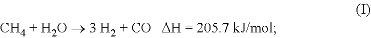

and dry reforming of methane (DRM) according to formula (II):

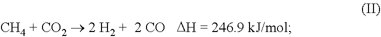

as well as for the combination of these two processes (combined steam-dry reforming (CSDR)).

The inventors have observed that prior art processes for methane conversion are only about 80% efficient, limited by the thermodynamic equilibrium at current process temperatures.

Numerous publications and references are directed to production of syngas wherein heat produced via combustion of natural gas is replaced with electric heating, e.g., via resistance heating, electric arc furnaces, and the like. Other references are directed to utilizing plasma to provide the heat necessary for production of syn-gas by conversion of natural gas, or other low-value hydrocarbons mixed with CO₂ and/or water vapor (i.e., steam, H₂O).

Since the major component of natural and associated gases is methane (CH₄), it is possible to describe the process as methane reforming. The inventors have observed an issue with plasma-based syngas production by the methane reforming. Methods of syngas production which utilize plasma are plagued with soot formation, i.e., carbonaceous solids, which results in forming deposits on the surfaces of plasma reactors and/or catalyst if the plasma is combined with a catalyst as part of the reforming process.

The most commonly practiced methane reforming process is SMR, which is also the dominant commercial process for producing hydrogen (H₂), due to the subsequent water-gas shift reaction (III):

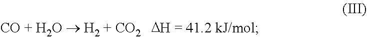

Accordingly, hydrogen production process based on SMR can be described by a gross reaction (IV):

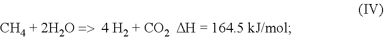

SMR is a well-developed industrial process that accounts for over 95% of the total hydrogen currently produced. SMR is typically performed in a radiation furnace where a catalyst, usually nickel on alumina, is contained in tubes heated by external burners fueled by natural gas. Because of additional NG consumption by the burners, an SMR plant is estimated to emits between 8 and 12 kg of CO₂ for each kg of hydrogen produced, instead of the 5.5 kg of CO₂ for each kg of hydrogen produced according to equation (IV). In addition, SMR is catalyst based, and as such it has drawbacks typical for catalytic processes including low productivity per volume of equipment, high capital cost, limited lifetime of the catalyst, and the like, rendering SMR production of hydrogen to be economically viable only in a large-scale process.

Dry reforming of methane (DRM) is based on a strongly endothermic reaction. DRM is not currently practiced on a commercial scale. Not wishing to be bound by theory, it is believed that this DRM process is not commercialized because in addition to the SMR drawbacks mentioned above, a byproduct of DRM is the formation of carbonaceous solids (i.e., soot), which tends to cover catalytic surfaces greatly reducing yields.

Plasma methods for natural gas conversion to syn-gas are also known. Plasma-assisted catalyst-free DMR with low-temperature plasmas produced via corona discharge, dielectric-barrier discharge, and the like, show insignificant reagent conversion. Furthermore, it is commonly understood in the art that while conducting plasma assisted methane reforming “carbon deposition is inevitable whatever the operating temperature is” (See Chung, W. C. and Chang, M. B., 2016. Review of catalysis and plasma performance on dry reforming of CH₄ and possible synergistic effects. Renewable and Sustainable Energy Reviews, 62, pp. 13-31.)

In addition, references directed to plasma-assisted DRM, with and without catalyst, including both those based on experimental data and modeling data, consider mostly non-equilibrium plasma and non-equilibrium chemical processes. The use of thermal (equilibrium) plasma of high current arcs, inductively coupled plasmas, etc. for direct or indirect process heating, or warm (non-equilibrium, but with high gas temperature of 2,000-5,000 K) plasmas (See, for example, Pacheco, J., Valdivia-Barrientos, R., Pacheco, M., de León, J. J. M. P. and Salazar-Torres, J. A., 2018. Warm Plasma Torch for Hydrocarbon Reforming. IEEE Transactions on Plasma Science, 46(7), pp. 2413-2419) The current understanding in the art is that of low-current arcs, gliding arcs, gliding atmospheric pressure glow discharges, and the like, shows significant production of solid carbon (soot) as a byproduct. (See, for example, Hrabovsky, M., Hlina, M., Kopecky, V., Maslani, A., Krenek, P., Serov, A. and Hurba, O., 2018. Steam plasma methane reforming for hydrogen production. Plasma Chemistry and Plasma Processing, 38, pp. 743-758; see also Wang, W., Snoeckx, R., Zhang, X., Cha, M. S. and Bogaerts, A., 2018. Modeling plasma-based CO₂ and CH₄ conversion in mixtures with N₂, O₂, and H₂O: the bigger plasma chemistry picture. The Journal of Physical Chemistry C, 122(16), pp. 8704-8723.)

Other references directed to plasma assisted DRM report processes with soot avoidance. However, such processes utilize gliding arc reactors wherein the fraction of converted carbon from methane and CO₂ present do not exceed 25%. Low conversion is the major and unavoidable feature of the gliding arc reactor with rather low average Specific Energy Input (SEI) and low average temperatures. (See Czernichowski, A., 2001. GlidArc assisted preparation of the synthesis gas from natural and waste hydrocarbons gases. Oil₂ Gas Science and Technology, 56(2), pp. 181-198.) Others include utilizing self-triggered spark reactors, which also suffer from relatively low conversion rates (See Shapoval, V. and Marotta, E., 2015. Investigation on plasma-driven methane dry reforming in a self-triggered spark reactor. Plasma Processes and Polymers, 12(8), pp. 808-816.)

There is a need for plasma-enabled methane reforming at commercially acceptable conversion rates which do not produce significant amounts of soot.

With the foregoing in view, the inventors have invented a plasma-enabled method to produce syngas having commercially acceptable conversion rates and which produces little if any carbonaceous solids (soot).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. In embodiments, a method to produce syngas comprises continuously flowing a mixture comprising a hydrocarbon, and a gaseous converting agent comprising one or more of carbon dioxide (CO₂) and water vapor (H₂O), at an inlet temperature through a reactor inlet into a plasma-chemical reactor while inputting an amount of electrical energy into the mixture thereby forming a plasma from the mixture within the plasma-chemical reactor thereby increasing an enthalpy of the mixture sufficiently to form a product syngas comprising hydrogen, carbon monoxide, and less than or equal to about 0.1 mol % solid carbonaceous compounds, based on a total amount of carbon initially present in the mixture; and flowing the product syngas through a reactor outlet of the plasma-chemical reactor and cooling the product syngas to a temperature of less than or equal to about 700 K, wherein a conversion of the hydrocarbon is greater than or equal to about 90 mol %, based on an initial amount of the hydrocarbon present in the mixture.

Such embodiments are shown in and/or described in connection with at least one of the figures, as set forth more completely in the claims. Various advantages, aspects and novel features of the present disclosure, as well as details of illustrated embodiments thereof, will be more fully understood from the following description and drawings.

### DESCRIPTION OF THE DRAWINGS

So that the manner in which the above recited features of embodiments of the instant disclosure can be understood in detail, a more particular description of the embodiments, briefly summarized above, may be made by reference to embodiments, some of which are illustrated in the appended drawings. It is to be noted, however, that the appended drawings illustrate typical embodiments of this disclosure and are therefore not to be considered limiting of its scope, for the invention disclosed herein may admit to other equally effective embodiments.

FIG. 1 is a diagram depicting a reverse-vortex plasmatron according to embodiments disclosed herein.

FIG. 2 is a diagram depicting the arc discharge plasma produced within the reverse-vortex plasmatron shown in FIG. 1 according to embodiments disclosed herein.

FIG. 3 is a graph depicting molar chemical composition of experimental gas flows after a plasma-chemical reactor with a cooler during a half-hour test according to embodiments disclosed herein.

FIG. 4 is a graph depicting minor components of the composition shown in FIG. 3.

FIG. 5 is a flowchart depicting a method to produce syngas according to embodiments disclosed herein.

FIG. 6 is a graph showing experimental results according to embodiments disclosed herein.

FIG. 7 is a graph showing experimental results according to embodiments disclosed herein.

FIG. 8 is a diagram depicting a general schematic of the equipment necessary to produce syngas according to embodiments disclosed herein.

### DETAILED DESCRIPTION

At the outset, it should be noted that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Likewise, each limitation of an embodiment should be read once as comprising that embodiment, then again as consisting essentially of that embodiment, then again as consisting of that embodiment, unless otherwise indicated. For brevity, the term comprising is used throughout unless otherwise indicated.

The following definitions are provided in order to aid those skilled in the art in understanding the detailed description.

As used in the specification and claims, “near” is inclusive of “at.”

For use herein, the expressions “have”, “may have”, “include”, “comprise”, “may include”, and “may comprise” indicate the existence of corresponding features (e.g., such as numeric values, functions, operations, or components) but do not exclude the presence of additional features.

In the present disclosure, expressions such as, “A or B” represents an alternative selection which, for example, refer to the case (1) where A is included or (2) where B is included, but does not represent the case where both A and B are included.

In the present disclosure, expressions such as, “A and/or B”, “at least one of A and/or B”, “one or more of A and/or B”, and the like, refer to a case which may include any and all combinations of one or more of the associated listed items. For example, the terms “A and/or B”, and “at least one of A or B” may refer to the case (1) where A is included, (2) where B is included, or (3) where both A and B are included.

Terms such as “first”, “second”, and the like used herein may refer to various elements of various embodiments disclosed herein, but it is to be understood that these labels do not limit the elements to any particular order, amount, or importance; such terms are used only to distinguish an element from another element and do not limit the order and/or priority of the elements. Likewise, such terms are used relative to others and do not represent absolute location, place, or order. For example, without departing from the scope of the present disclosure, a first element of one embodiment may be referred to as a second element in another embodiment, and similarly, a second element may be referred to as a first element.

For purposes herein, a ratio of oxygen atoms to carbon atoms present in a feed mixture is determined according to the molar flow rates of all substances involved and their atomic compositions. For example, if a stoichiometric mixture for dry conversion per formula (1) is taken, CH₄+CO₂, the total flow rate of carbon atoms is exactly equal to the total flow rate of oxygen atoms, while these flow rates are twice lower than the flow rate of hydrogen atoms.

In embodiments, a method to produce syngas, comprises continuously flowing a mixture comprising a hydrocarbon, and a gaseous converting agent comprising one or more of carbon dioxide (CO₂) and water vapor (H₂O), at an inlet temperature through a reactor inlet into a plasma-chemical reactor while inputting an amount of electrical energy into the mixture thereby forming a plasma from the mixture within the plasma-chemical reactor thereby increasing an enthalpy of the mixture sufficiently to form a product syngas comprising hydrogen, carbon monoxide, and less than or equal to about 0.1 mol % solid carbonaceous compounds, based on a total amount of carbon initially present in the mixture; and flowing the product syngas through a reactor outlet of the plasma-chemical reactor and cooling the product syngas to a temperature of less than or equal to about 700 K, wherein a conversion of the hydrocarbon is greater than or equal to about 90 mol %, or greater than or equal to about 95%, or greater than or equal to about 98%, based on an initial amount of the hydrocarbon present in the mixture. In embodiments of the method, the electrical energy input into the mixture is over a period of time of less than or equal to about 0.1 seconds, or less than or equal to about 0.01 seconds, or less than or equal to about 0.001 seconds.

In embodiments of the method, a total amount of energy input into the mixture is from about 400 kJ per mol of CO₂ to about 1,400 kJ per mol of CO₂, wherein the total amount of energy input is equal to an amount of energy input required to increase the enthalpy of the mixture from an enthalpy of the mixture at a temperature of 373 K, and wherein the total amount of energy input is calculated according to Formula (I):

$${E}_{total} = {E}_{plasma} + ( {H}_{input} - {H}_{373 K} ) \qquad ( I )$$

wherein Eₜₒₜₐₗ is the total amount of energy input;
Eₚₗₐₛₘₐ is the amount of electrical energy input into the mixture to form the plasma;
Hᵢₙₚᵤₜ is the enthalpy of the mixture at the inlet temperature; and
H_{373K} is the enthalpy of the mixture at 373K.

In some embodiments, a total amount of energy input into the mixture is from about 400 kJ per mol to about 720 kJ per mol CO₂, or from about 400 kJ per mol to about 480 kJ per mol CO₂.

In embodiments of the method, a total amount of energy input into the mixture is from about 360 kJ per mol of H₂O to about 1,300 kJ per mol of H₂O, wherein the total amount of energy input is equal to an amount of energy input required to increase the enthalpy of the mixture from an enthalpy of the mixture at a temperature of 373 K, and wherein the total amount of energy input is calculated according to Formula (I):

$${E}_{total} = {E}_{plasma} + ( {H}_{input} - {H}_{373 K} ) \qquad ( I )$$

wherein Eₜₒₜₐₗ is the total amount of energy input;
Eₚₗₐₛₘₐ is the amount of electrical energy input into the mixture to form the plasma;
Hᵢₙₚᵤₜ is the enthalpy of the mixture at the inlet temperature; and
H_{373K} is the enthalpy of the mixture at 373° K.

In some embodiments, a total amount of energy input into the mixture is from about 360 kJ per mol to about 680 kJ per mol H₂O, or from about 360 kJ per mol to about 440 kJ per mol H₂O.

In embodiments, the gaseous converting agent further comprises oxygen (O₂), wherein the total amount of energy input into the mixture is increased by less than or equal to about 40 kJ per mol of O₂. In embodiments, the amount of oxygen (O₂) in the gaseous converting agents is less than or equal to about 80 mol %.

In embodiments, the ratio of oxygen atoms to carbon atoms in the mixture is from about 0.95 to about 1.15. In some embodiments, the ratio of oxygen atoms to carbon atoms in the mixture is from about 0.98 to 1.05, or about 1 to 1.

In embodiments, the inputting of the electrical energy into the mixture thereby forming the plasma from the mixture comprises an electric discharge. In some embodiments, the electric discharge is a warm plasma discharge. In some embodiments, the warm plasma discharge comprises an electric arc with a time-averaged arc current of less or equal to about 15 A per mol/min flow rate of the mixture, or less or equal to about 10 A per mol/min flow rate of the mixture, at a voltage of greater than or equal to about 300 V, or greater than or equal to about 400 V, or greater than or equal to about 500 V, which are commonly referred to in the art as high-voltage low-current conditions for forming an electric arc.

In embodiments, the plasma-chemical reactor comprises a reverse-vortex plasmatron comprising an essentially axisymmetric plasmatron volume disposed between a first end and a second open end, wherein the second open end comprises a plasmatron outlet, wherein a plasmatron inlet is configured to flow the mixture tangentially into the plasmatron volume, and wherein the plasmatron inlet is proximate to the second open end.

In embodiments, the gaseous converting agents comprise up to about 100 mol % carbon dioxide (CO₂) and from about 100 to 0 mol % water vapor (H₂O). In some embodiments, the gaseous converting agents further comprise from 0 to about 80 mol % oxygen (O₂).

In embodiments, the gaseous converting agents consists essentially of carbon dioxide (CO₂), water vapor (H₂O), oxygen (O₂), or a combination thereof. In some embodiments, the gaseous converting agents consists essentially of carbon dioxide (CO₂). In some embodiments, the gaseous converting agents consists essentially of water vapor (H₂O).

In embodiments, the inlet temperature of the mixture is less than or equal to about 1,000 K, or less than or equal to about 700 K, or less than or equal to about 600 K.

In embodiments, the mixture is preheated from an initial temperature to the inlet temperature via heat exchange.

In embodiments, the method further comprises separating at least a portion of the hydrogen from the product syngas. In embodiments, the method further comprises recycle of at least a portion and/or a component of the product syngas stream flowing from the reactor outlet of the plasma-chemical reactor back into the plasma-chemical reactor through the reactor inlet.

The inventors have discovered that the formation of solid phase materials during reforming, e.g., soot formation, is a kinetically slow process in comparison with the gaseous processes at high temperatures. Analysis comprising chemical kinetic modeling and thermodynamic simulations were conducted using Chemical Workbench (CWB) software.

Thermodynamic modelling was conducted to evaluate soot formation versus temperature. Results of similar thermodynamic simulations can be found in publication by Essiptchouk, Miranda, and Petraconi (Essiptchouk, A., Miranda, F. and Petraconi, G., 2024. Comparative analysis of methane conversion: pyrolysis, dry and steam thermal plasma reforming. Journal of Physics D: Applied Physics, 57(24), p. 245201.) The inventors observed that dry reforming of methane (DRM) is more prone to soot (also called solid carbon, i.e., “C(s)”) formation than steam methane reforming (SMR), which is one of the major reasons why SMR is widely commercialized in contrast to DRM. This finding is consistent with the observation that for high conversion of reagents and avoidance of soot formation, in both cases, it is necessary to reach temperature of the products of about 1500 K.

The inventors conducted chemical kinetic simulation of various DRM and SMR processes which showed that relatively slow heating over a period of about 1000 seconds of a stoichiometric mixture for dry conversion per formula (I) results in soot formation.

Accordingly, it was found that the reaction time affects soot formation. For example, fast heating over a period on the order of 1 millisecond (ms) of a stoichiometric mixture for dry conversion per formula (1) avoids soot formation in noticeable quantities.

It was further discovered that an initial fast energy input over a period on the order of less than or equal to about 1 second, or less than or equal to about 0.1 second, or less than or equal to about 0.01 seconds, or less than or equal to about 0.001 seconds, of greater than about 480 kJ per mol of CO₂, and greater than about 440 kJ per mol of H₂O with further cooling results in methane conversion without soot formation.

It was further discovered that an initial fast e.g., over a period of less than or equal to about 1 second, or less than or equal to about 0.1 second, or less than or equal to about 0.01 second, or less than or equal to about 0.001 seconds, of energy input of greater than or equal to about 480 kJ per mol of CO₂, and 440 kJ per mol of H₂O with a consequent 1 second adiabatic process phase and further cooling results in methane conversion without soot formation. In embodiments, the plasma chemical reactor further includes an adiabatic portion.

It was further discovered that an improvement was obtained by pre-heating the mixture to a temperature of lower than or equal to about 1000 K, or lower than or equal to about 800 K, or lower than or equal to about 700 K, prior to directing the mixture into the reactor due to the rather slow progress of the various chemical reactions at these lower temperatures. This preheating allows to recover some energy during process cooling in a heat exchanger, which in embodiments is used to preheat the mixture of the reagents, directed into the reactor.

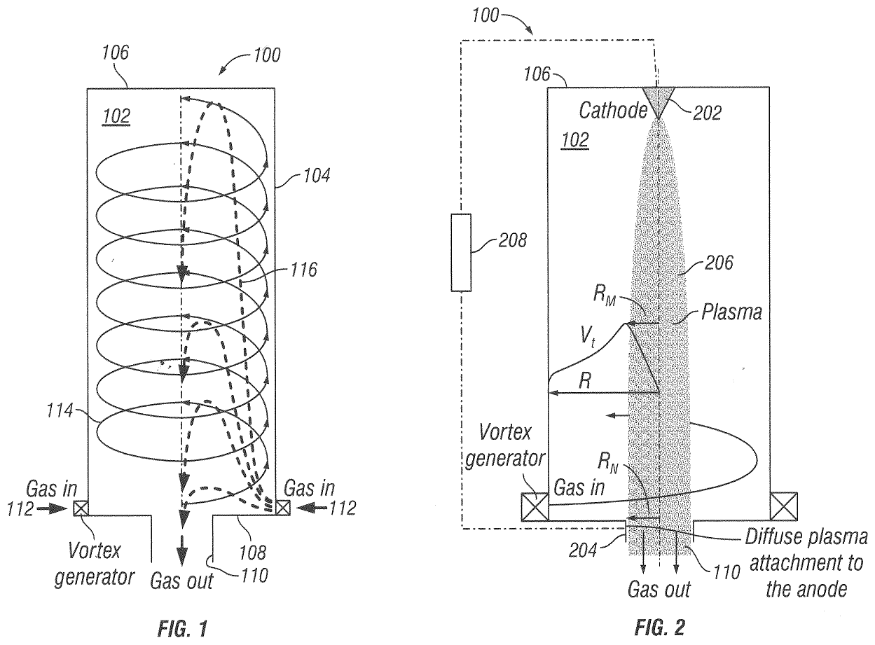

The results of the above modeling were validated experimentally using a reverse-vortex plasmatron (100 in FIG. 1) as a plasma-chemical reactor with low-current high-voltage arc discharge 206 depicted in FIG. 2. In embodiments, the reverse-vortex plasmatron 100 having a sidewall 104 surrounding an axisymmetric plasmatron volume 102, which has an essentially cylindrical shape and an open end 108 comprising the plasmatron outlet 110. One or more plasmatron inlets 112 are configured to flow the mixture tangentially (as indicated by line 114) into the plasmatron volume 102 proximate to the open end 108 with the plasmatron outlet 110, which may include use of a vortex generator or other arrangements. The resulting flow pattern of the gas formed by the reverse vortex flow within the axisymmetric plasmatron volume 102 then exits the plasmatron 100 through the plasmatron outlet 110. The dashed lines 116 represent a flow pattern in the axial plane of the plasmatron 100.

In embodiments, the reactor includes a reverse-vortex plasmatron. Syngas from the reactor moves through a cooler (heat-exchanger), and at the cooler exit temperature of the syngas flow drops below 700 K. Optionally, the whole or partial flow of reagents can be preheated in the heat exchanger, then the preheated flow optionally mixes with the rest of the flow of the reagents, and the total preheated flow of the reagents enters the plasma-chemical reactor inlet with temperature below 1000 K, or below 700 K, or below 600 K. In FIG. 2, the reactor inlet is also an inlet of the arc plasmatron. A power supply 208 provides electric power to support plasma in the plasmatron volume 102. Optionally, the reactor includes an adiabatic portion or other chamber where the high-temperature products exiting the plasmatron through the outlet continue chemical conversions, and then the hot syngas flow exits the reactor.

As shown in FIG. 2, the first arc electrode 202 is located at or proximate to the first end 106, and the second arc electrode 204 is located at or proximate to the plasmatron outlet 110.

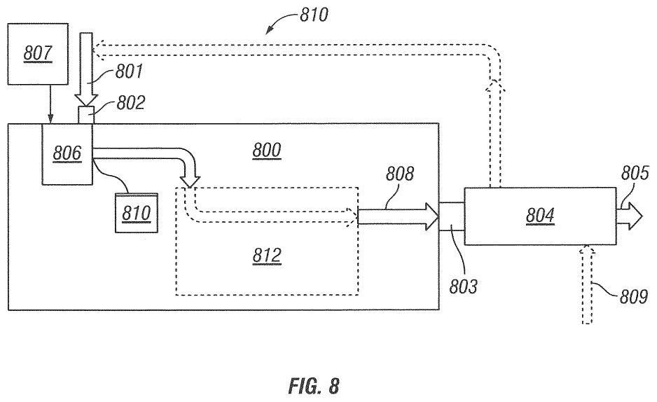

In embodiments as depicted in FIG. 8, the reactor 800 includes a reverse-vortex plasmatron 806 having the plasmatron outlet 810. In the simplest embodiment, the reactor 800 include the plasmatron 806, and the plasmatron outlet 810 is the same as the reactor outlet 803. Syngas from the reactor moves through the heat-exchanger 804, and at the cooler exit temperature of the syngas flow 805 drops below 700 K. Optionally, the whole or partial flow of reagents 809 can be preheated in the heat exchanger 804, then the preheated flow optionally mixes with the rest of the flow of the reagents, and the total preheated flow of the reagents 801 enters the reactor inlet 802 with temperature below 1000 K, or below 900 K, or below 850 K. The reactor inlet 802 is also an inlet of the plasmatron 806. Power supply 807 provides electric power to support plasma in plasmatron 806. Optionally, the reactor 800 includes an adiabatic portion or chamber 812 where the high-temperature products exiting the plasmatron through the plasmatron outlet 810 continue chemical conversions, and then the hot syngas flow 808 goes to the reactor outlet 803 and heat exchanger 804.

It was discovered that the reverse-vortex plasma reactor can be configured to such that the flow within the reactor can be free of circulation zones, and thus all portions of the incoming mixture can quickly receive their proportional portions of the total energy input, which was discovered to provide an improvement of greatly reducing and/or eliminating the formation of soot.

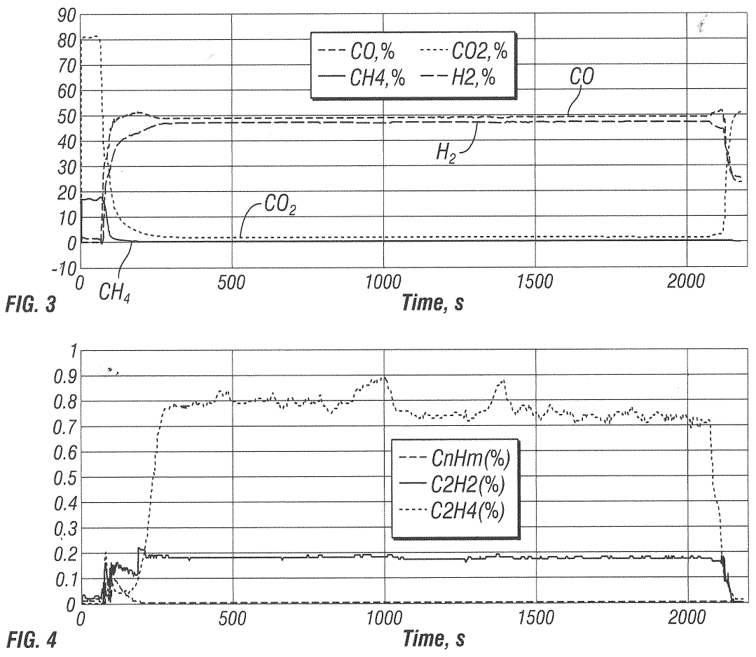

FIGS. 3 and 4 show the chemical composition of the gas flow in mol. % after the plasma-chemical reactor with a cooler at the exit during a half-hour test of a plasmatron according to embodiments disclosed herein. FIG. 3 shows concentrations of the major syngas components: H₂, CO, CO₂ and CH₄, while FIG. 4 shows minor components detected, acetylene, ethylene, and undetermined hydrocarbons CₙHm. During this test the major parameters of the test were kept constant: flow rates of the reagents were 5.03 SLPM for CO₂ and 4.97 SLPM for CH₄. The plasmatron was powered with DC stabilized current of 3.502 A, which corresponded to about 8.6 A per mol/min flow rate that is typical for a low-current plasmatron. Because of oscillation of the arc length with average frequency of 33.8 kHz, arc voltage and power had oscillation with the same frequency with relative deviation of 13%, while the average arc voltage was about 800 V, which is typical for high-voltage plasmatrons, and power was 2.911 kW with long term relative deviations of less than 0.5%. Average gross energy input was about 850 kJ per mol of CO₂. Considering that the thermal efficiency of the plasmatron is estimated to be 80%, this corresponds to the total amount of energy input into the mixture of about 680 kJ per mol of CO₂.

The molar chemical composition of the gas flow presented in FIGS. 3 and 4 were measured by a syngas analyzer on the dry basis. The gas flow humidity was also measured, and the absolute H₂O content varied slowly in the range 2-3 mol %, comparable with the concentration of CO₂ (1.83 vol % in average), because concentrations of H₂, CO, H₂O, and CO₂ are connected through the equilibrium constant of the water-gas shift reaction (See formula (III)).

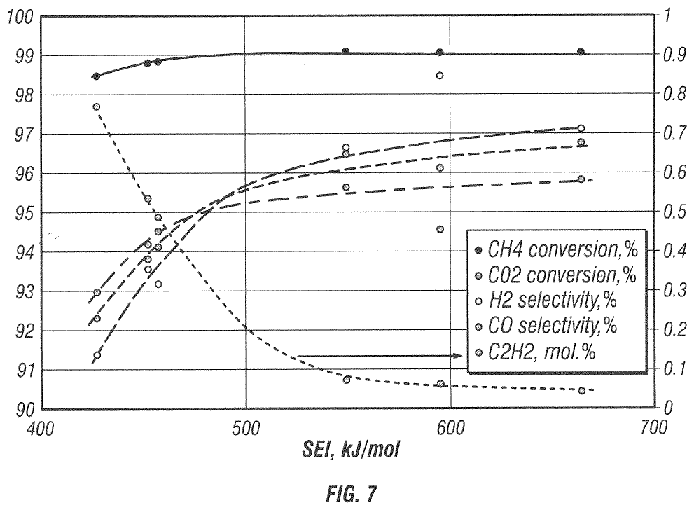

FIG. 7 shows a dependence of the major chemical parameters (conversion rates for CH₄ and CO₂, and selectivity of the process towards H₂ and CO production) and time-averaged acetylene concentration on specific energy input (SEI) that is electric energy delivered per flow of reagents for multiple DRM experiments, where flow rate of CO₂ exceeded that of CH₄ by 1-2%. During these experiments, the ratio of oxygen atoms to carbon atoms in the mixture fed into the reactor was from about 1.01 to 1.02. These data confirmed a dependence of acetylene concentration on SEI, however, the tests did not reveal a correlation between SEI in the tested range and soot formation selectivity that was between 0.011% and 0.018%.

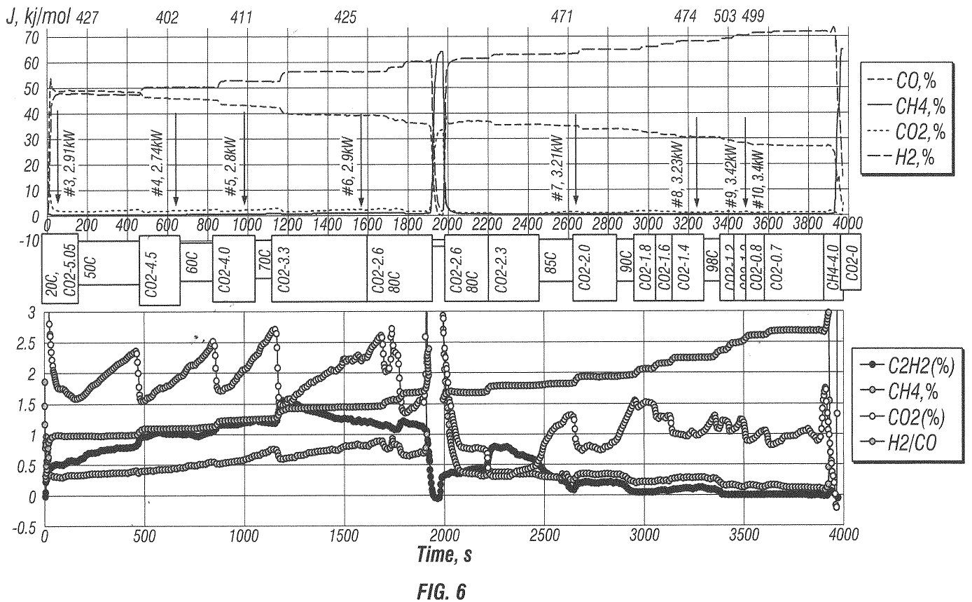

FIG. 6 presents data of experiments according to embodiments disclosed herein, wherein the horizontal time axis of the upper and lower portions of the figure are aligned. The inventors have further observed that plasma conversion of methane to syngas according to embodiments disclosed herein allow for the possibility of changing the H₂:CO ration from 1:1 up to about 3:1 by replacing a portion of CO₂ with steam. As FIG. 6 shows the record of the experiment with the same plasmatron when carbon dioxide was replaced in stages by steam while CH₄ flow rate was kept constant at 4.95 SLPM (it was reduced to 4 SLPM at the very end of the test when it became clear that the process needs more plasma power than the plasmatron can provide). Steam was supplied through a humidifier, and the whole flow rate of the reagents was heated to 120° C. The text boxes between two graphs show the records of the humidifier temperature settings and CO₂ flow rates settings. The record shows that in the middle of the test, plasma was lost because of the voltage limitation settings on the power supply, and then restarted when the settings were improved. It is possible to see that increase of steam flow rate with increase of the humidifier temperature required the power increase for plasma support, probably because higher concentration of hydrogen in the products resulted in higher thermal losses to the plasmatron walls by thermal conductivity. When the humidifier temperature reached 85° C. and the plasma power reached 3.21 kW that corresponds to the total energy input of 471 kJ per mole of reagents, H₂/CO molar ratio in produced syngas reached 2, which is a desirable value for Fischer-Tropsch process. The plasmatron did not allow the inventors to reach pure steam conversion, but the H₂/CO molar ratio of 2.7 was reached. It is important that when the humidifier temperature reached 98° C. (CO₂/H₂O ratio dropped below 0.16) and the plasma power reached 3.42 kW that corresponds to the total energy input of about 500 kJ per mole of reagents, concentration of acetylene in the product flow dropped to zero, which probably means complete absence of soot in the product flow. This confirms the conclusion made based on thermodynamic simulations that SMR is less prone to soot production than DRM.

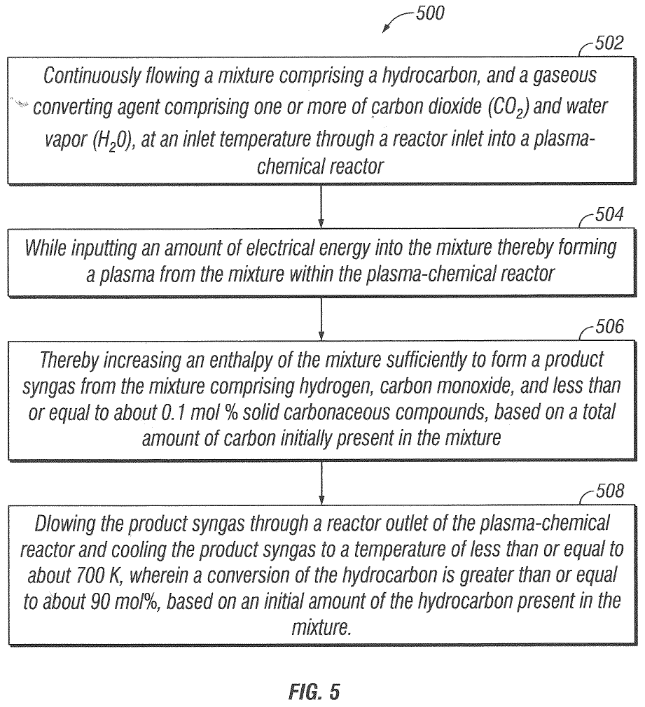

FIG. 5 is a flowchart depicting a method 500 to produce syngas according to embodiments disclosed herein. The method 500 includes continuously flowing a mixture comprising a hydrocarbon, and a gaseous converting agent comprising at least one of carbon dioxide (CO₂), water vapor (H₂O), or a combination thereof, at an inlet temperature through a reactor inlet into a plasma-chemical reactor (block 502); while inputting an amount of electrical energy into the mixture thereby forming a plasma from the mixture within the plasma-chemical reactor (block 504); thereby increasing an enthalpy of the mixture sufficiently to form a product syngas comprising hydrogen, carbon monoxide, and less than or equal to about 0.1 mol % solid carbonaceous compounds, based on a total amount of carbon initially present in the mixture (block 506); and flowing the product syngas through a reactor outlet of the plasma-chemical reactor and cooling the product syngas to a temperature of less than or equal to about 700 K, wherein a conversion of the hydrocarbon is greater than or equal to about 90 mol %, based on an initial amount of the hydrocarbon present in the mixture (block 508).

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

1. A method to produce syngas, comprising:
continuously flowing a mixture comprising a hydrocarbon, and a gaseous converting agent comprising at least one of carbon dioxide (CO₂), water vapor (H₂O), or a combination thereof, at an inlet temperature through a reactor inlet into a plasma-chemical reactor while inputting an amount of electrical energy into the mixture thereby forming a plasma from the mixture within the plasma-chemical reactor thereby increasing an enthalpy of the mixture sufficiently to form a product syngas comprising hydrogen, carbon monoxide, and less than or equal to about 0.1 mol % solid carbonaceous compounds, based on a total amount of carbon initially present in the mixture; and
flowing the product syngas through a reactor outlet of the plasma-chemical reactor and cooling the product syngas to a temperature of less than or equal to about 700 K, wherein a conversion of the hydrocarbon is greater than or equal to about 90 mol %, based on an initial amount of the hydrocarbon present in the mixture.

2. The method of claim 1, wherein the electrical energy input into the mixture is over a period of time of less than or equal to about 0.1 seconds.

3. The method of claim 1, wherein a ratio of oxygen atoms to carbon atoms in the mixture is from about 0.95 to about 1.15.

4. The method of claim 3, wherein a total amount of energy input into the mixture is from about 400 kJ per mol of CO₂ to about 1,400 kJ per mol of CO₂, and from about 360 kJ per mol of H₂O to about 1,300 kJ per mol of H₂O;
wherein the total amount of energy input is equal to an amount of energy input required to increase the enthalpy of the mixture from an enthalpy of the mixture at a temperature of 373 K,
wherein the total amount of energy input is calculated according to Formula I:
$${E}_{total} = {E}_{plasma} + ( {H}_{input} - {H}_{373 K} ) \qquad ( I )$$
wherein Eₜₒₜₐₗ is the total amount of energy input in J/mol;
Eₚₗₐₛₘₐ is the amount of electrical specific energy input into the mixture to form the plasma in J/mol;
Hᵢₙₚᵤₜ is the enthalpy of the mixture at the inlet temperature in J/mol; and
H_{373K} is the enthalpy of the mixture at 373K in J/mol.

5. The method of claim 4, wherein the gaseous converting agent further comprises oxygen (O₂), and wherein the total amount of energy input into the mixture is increased by less than or equal to about 40 kJ per mol of O₂.

6. The method of claim 1, wherein the inputting of the electrical energy into the mixture thereby forming the plasma from the mixture comprises an electric discharge.

7. The method of claim 6, wherein the electric discharge is a warm plasma discharge.

8. The method of claim 7, wherein the warm plasma discharge comprises a high-voltage low-current electric arc with a time-averaged arc current of less than or equal to about 15 A per mol/min flow rate of the mixture at a voltage of greater than or equal to about 300 V.

9. The method of claim 1, wherein the plasma-chemical reactor comprises a reverse-vortex plasmatron comprising an essentially axisymmetric plasmatron volume disposed between a first end and a second open end, wherein the second open end comprises a plasmatron outlet, wherein a plasmatron inlet is configured to flow the mixture tangentially into the plasmatron volume; and
wherein the plasmatron inlet is disposed proximate to the second open end.

10. The method of claim 1, wherein the gaseous converting agents comprise from 0 to about 100 mol % carbon dioxide (CO₂) and from about 100 mol % to 0 water vapor (H₂O).

11. The method of claim 1, wherein the gaseous converting agents comprise from 0 to about 80 mol % oxygen (O₂).

12. The method of claim 1, wherein the gaseous converting agents consists essentially of carbon dioxide (CO₂), water vapor (H₂O), oxygen (O₂), or a combination thereof.

13. The method of claim 1, wherein the gaseous converting agents consists essentially of carbon dioxide (CO₂).

14. The method of claim 1, wherein the gaseous converting agents consists essentially of water vapor (H₂O).

15. The method of claim 1, wherein the inlet temperature is less than or equal to about 1,000 K.

16. The method of claim 1, wherein the mixture is preheated from an initial temperature to the inlet temperature via heat exchange.

17. The method of claim 1, further comprising separating at least a portion of the hydrogen from the product syngas.
